(19) United States
(12) Patent Application Publication
(10) Pub. No.: US 2025/0121614 A1
(43) Pub. Date: Apr. 17, 2025

(54) IMAGE FORMING APPARATUS, IMAGE FORMING METHOD, AND RECORDING MEDIUM

(71) Applicant: Noboru Hirano, KANAGAWA (JP)

(72) Inventor: Noboru Hirano, KANAGAWA (JP)

(73) Assignee: Ricoh Company, Ltd., Tokyo (JP)

(21) Appl. No.: 18/906,593

(22) Filed: Oct. 4, 2024

(30) Foreign Application Priority Data
Oct. 11, 2023 (JP) 2023-176119

(51) Int. Cl. B41J 11/00; B41J 3/60; B41J 13/26

(52) U.S. Cl. CPC B41J 11/008; B41J 3/60; B41J 11/0095; B41J 13/26

(57) ABSTRACT

An image forming apparatus includes a conveyance device, a printing device, an image reading device, and circuitry. The image reading device reads a print position based on an image formed by the printing device. The circuitry detects an amount of change in the print position that is read relative to a target print position. The circuitry corrects an image position based on the detected amount of change. The image position is a position of an image to be formed on the recording medium in subsequent image formations. The circuitry determines the image position on the second side of the recording medium based on deviations of the print position on the first side of the recording medium from the target print position. The deviations include a deviation at a time of printing the first side, and a post-printing deviation after printing and are the detected amount of change.

### CROSS-REFERENCE TO RELATED APPLICATIONS

This patent application is based on and claims priority pursuant to 35 U.S.C. § 119 (a) to Japanese Patent Application No. 2023-176119, filed on Oct. 11, 2023, in the Japan Patent Office, the entire disclosure of which is hereby incorporated by reference herein.

### BACKGROUND

### Technical Field

The present disclosure relates to an image forming apparatus, an image forming method, and a non-transitory recording medium.

### Related Art

In the related art, printing devices read a position detection mark formed on the first side of a recording medium such as paper and the coordinates of an edge of the recording medium, and adjust a position of an image to be formed on the second side based on a read image of the first side before forming the image on the second side of the recording medium to prevent front-to-back misregistration.

### SUMMARY

According to an embodiment of the present disclosure, an image forming apparatus includes a conveyance device, a printing device, an image reading device, and circuitry. The conveyance device conveys a recording medium having a first side and a second side. The printing device forms an image on the conveyed recording medium. The image reading device reads a print position based on the formed image. The print position is a position of the formed image. The circuitry detects an amount of change in the print position that is read relative to a target print position. The circuitry corrects an image position based on the detected amount of change. The image position is a position of an image to be formed on the recording medium in subsequent image formations. The circuitry determines the image position on the second side of the recording medium based on deviations of the print position on the first side of the recording medium from the target print position. The deviations include a deviation at a time of printing the first side, and a post-printing deviation after printing and are the detected amount of change.

According to an embodiment of the present disclosure, an image forming method executed by an image forming apparatus having an image reading device, includes detecting, from an image printed on a recording medium having a first side and a second side, an amount of change in a print position read by the image reading device relative to a target print position. The image forming method includes determining an image position on the second side of the recording medium based on deviations of the print position on the first side of the recording medium from the target print position. The deviations include a deviation at a time of printing the first side, and a post-printing deviation after printing and are the detected amount of change. The image forming method includes correcting the image position based on the detected amount of change. The image position is a position of an image to be formed on the recording medium in subsequent image formations.

According to an embodiment of the present disclosure, a non-transitory recording medium storing a plurality of instructions which, when executed by one or more processors, causes the one or more processors to perform a method. The method includes detecting, from an image printed on a recording medium having a first side and a second side, an amount of change in a print position read by an image reading device relative to a target print position. The method includes determining an image position on the second side of the recording medium based on deviations of the print position on the first side of the recording medium from the target print position. The deviations include a deviation at a time of printing the first side, and a post-printing deviation after printing and are the detected amount of change. The method includes correcting the image position based on the detected amount of change. The image position is a position of an image to be formed on the recording medium in subsequent image formations.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a line-head type printing device according to an embodiment;

FIG. 2 is a diagram illustrating an example of a configuration of the image forming device included in the line-head type printing device according to the embodiment;

FIG. 3A is a diagram illustrating an example of a configuration of the image reading device included in the line-head type printing device according to the embodiment;

FIG. 3B is a block diagram illustrating an example of a functional configuration of a controller, a print engine, and an image position detector of the line-head type printing device according to the embodiment;

FIG. 3C is a block diagram illustrating an example hardware configuration of the image position detector;

FIG. 4A and FIG. 4B are diagrams illustrating an example of target coordinates and reading coordinates of the first side of the recording medium in the line-head type printing device according to the embodiment;

FIG. 5 is a diagram illustrating an example of the target coordinates and the reading coordinates for the first side and second side of the recording medium in the line-head type printing device;

FIG. 6A is a diagram illustrating an example of the printing coordinates of the second side in the comparative example;

FIG. 6B is a diagram illustrating an example of the printing coordinates of the second side according to the present embodiment;

FIG. 7A to FIG. 7C are diagrams illustrating an example of a front-to-back position misregistration due to the deviation in detecting the image position;

FIG. 8A to FIG. 8C are diagrams illustrating an example of correcting front-to-back position misregistration due to the deviation in detecting the image position;

FIG. 9 is a diagram illustrating side effects caused by correcting the deviation in detecting the image position and an example of countermeasures against the side effects; and

FIG. 10A and FIG. 10B are diagrams illustrating an example of coordinate formulas to compensate the side effects caused by correcting the deviation in detecting the image position.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

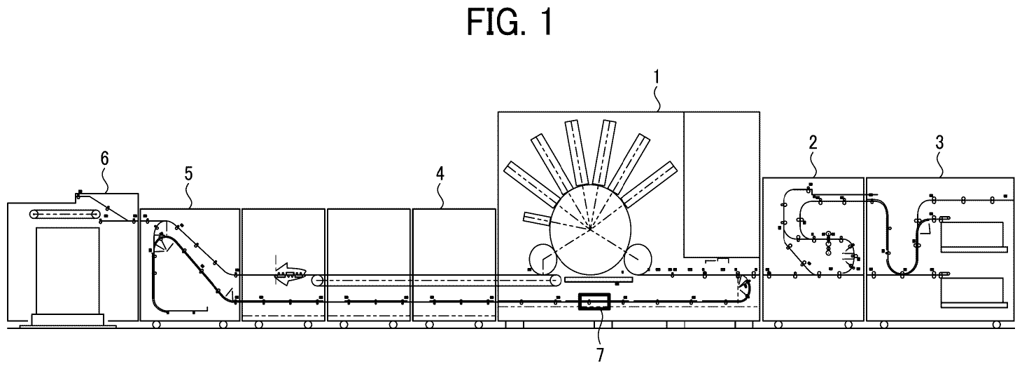

FIG. 1 is a diagram illustrating an example of a line-head type printing device according to an embodiment.

The line-head type printing device (an example of an image forming apparatus) includes an image forming device 1, a pre-coating device 2, a sheet feeder device 3, a drying-cooling device 4, a reversing device 5, a sheet ejection device 6, and an image reading device 7.

The sheet feeder device 3 is an example of a conveyance unit that feeds and conveys recording media such as sheets one by one. The pre-coating device 2 applies a pre-coating liquid to the sheet in advance. The pre-coating liquid helps the liquid such as ink to be easily fixed on the sheet even if the liquid can be hardly fixed on the sheet depending on the sheet. The image forming device 1 winds a sheet around a drum and prints (forms) an image on the sheet with a line head. The image forming device 1 detects a deviation in a main scanning direction before winding the sheet around the drum and shifts the image in the main scanning direction to print the image while correcting the deviation. In other words, the image forming device 1 is an example of a printing unit that forms an image on the conveyed sheet.

The drying-cooling device 4 dries moisture in the ink and fixes the ink on the sheet. The drying-cooling device 4 also includes a cooling unit, if necessary, to lower the temperature of the sheet, which is likely to increase. The reversing device 5 executes switchback reversal during to automatically print the backside of the sheet and conveys the sheet in the direction toward the image forming device 1.

The sheet ejection device 6 stacks the sheets each having the printed image. The image reading device 7 reads the printed image. The image reading device 7 is disposed in a double-sided conveyance path to read the image on the sheet at a time when the sheet is sufficiently stable as deformation does not occur, such as a time after drying and cooling and before printing an image on the other side of the sheet. In other words, the image reading device 7 is an example of an image reading unit that reads a print position from the image printed on the sheet. Alternatively, the image reading device 7 may include a first image reading unit that reads the image immediately after printing and a second image reading unit that reads the image after printing when the sheet is sufficiently stable.

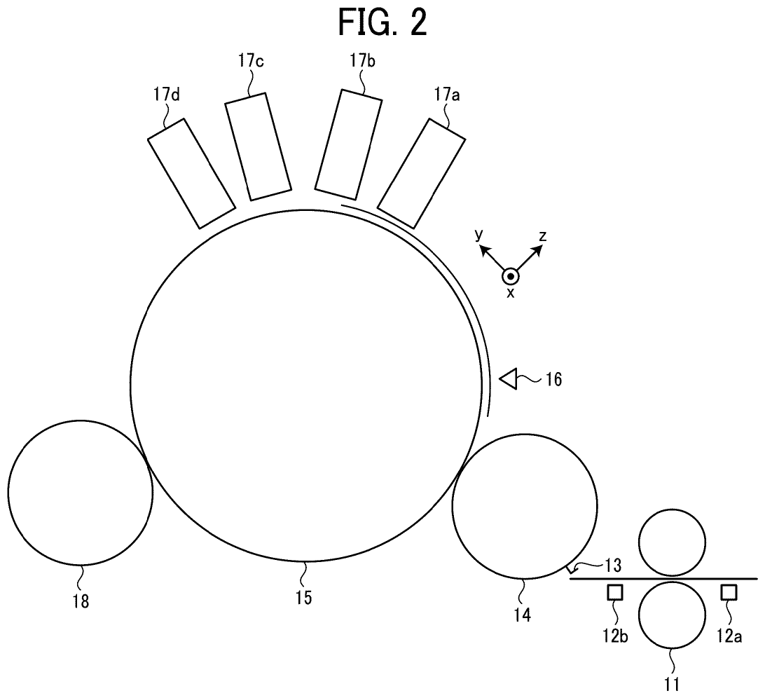

FIG. 2 is a diagram illustrating an example of a configuration of the image forming device 1 included in the line-head type printing device according to the embodiment. In the present embodiment, the image forming device 1 includes a shift roller 11, edge sensors 12a and 12b (e.g., linear image sensors), a gripper 13, an inlet cylinder 14, an image forming drum 15, a print timing sensor 16, print heads 17a, 17b, 17c, and 17d (line head KCMY,) and an exit cylinder 18. In the following description, the print heads 17a, 17b, 17c, and 17d may be referred to as print heads 17 unless they need to be distinguished from each other.

The image forming device 1 detects a main scanning positional deviation and skew amount of the recording medium such as the sheet entering the shift roller 11 with the edge sensors 12a and 12b and corrects the main scanning positional deviation and skew with the shift roller 11. Then, the image forming device 1 causes the gripper 13, which is attached to the inlet cylinder 14 and mechanically opens and closes, to grip the edge of the sheet. The inlet cylinder 14, the image forming drum 15, and the exit cylinder 18 are coupled by gears. The sheet is conveyed by the gripper 13 attached to each of the inlet cylinder 14, the image forming drum 15, and the exit cylinder 18 that sequentially grip the sheet.

The print heads 17 are line heads each including a series of inkjet print heads (e.g., colors of K, C, M, and Y) in the X-axis direction (the main scanning direction.) The print heads 17 eject ink to form an image when the sheet passes under the print heads 17. The image forming device 1 determines print timing, that is, a timing when the image is formed, based on timing when the sheet passes the print timing sensor 16.

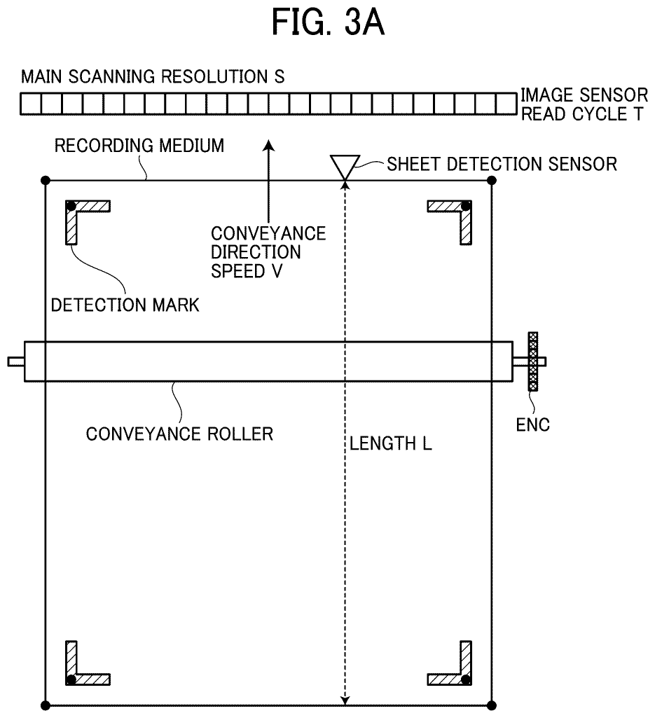

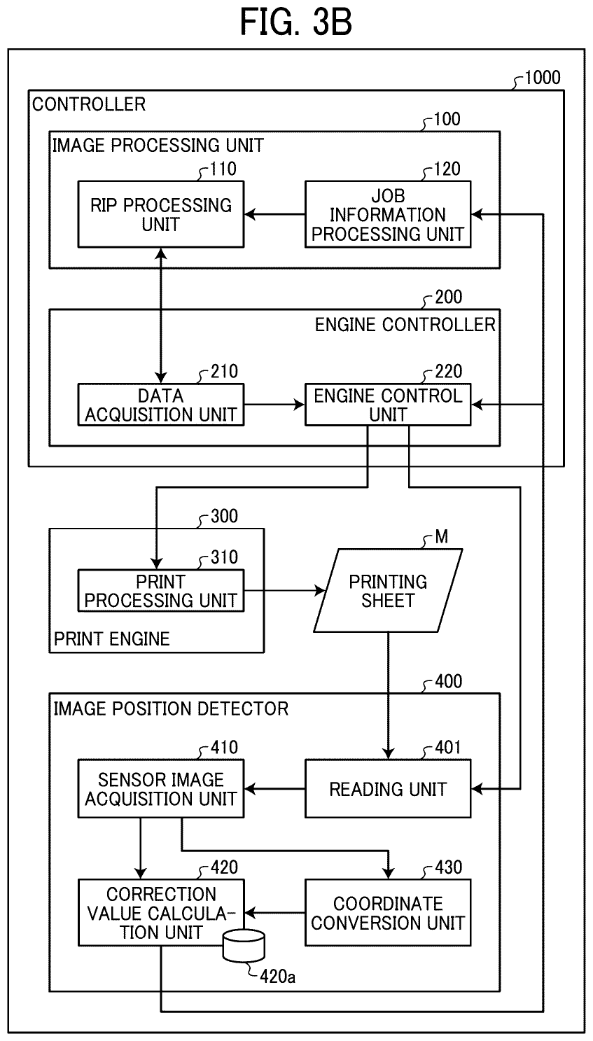

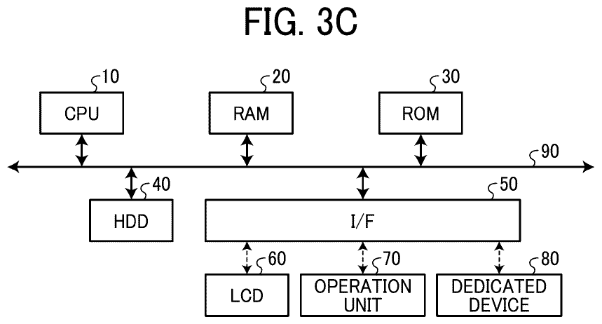

FIG. 3A is a diagram illustrating an example of a configuration of the image reading device 7 included in the line-head type printing device according to the embodiment. In the present embodiment, the image reading device 7 reads sheet edges which are four corners of the recording medium (e.g., paper) and detection marks with an image sensor (e.g., Compact Image Sensor (CIS)) disposed perpendicular to the conveyance direction, while conveying the recording medium at a conveyance speed V along the conveyance direction. The image reading device 7 detects the positions of the sheet edges and detection marks from the read images.

The image sensor does not have to be disposed in the main scanning direction as long as it is disposed at a position where the image sensor can detect the edges of the four corners of the recording medium and the detection marks. When the image sensor has a reading period T and a resolution S, the main scan resolution is S and the sub-scan resolution is V×T. When the conveyance speed V varies, the sub-scan resolution of the read image will vary. Therefore, it is preferable to keep the conveyance speed V as constant as possible.

Alternatively, a positional relationship between the sheet edge at the leading end of the recording medium and the detection mark, and a positional relationship between the sheet edge at the trailing end of the recording medium and the detection mark may be detected by the image sensor. The length L (a distance in the sub-scanning direction) of the recording medium in the sub-scan direction may be detected by detecting the leading end and trailing end of the recording medium with a paper detection sensor and measuring the conveyance distance of the recording medium with an encoder (ENC) attached to the conveyance roller shaft.

Because the sheet edges at the four corners of the recording medium and the detection marks are close to each other, the effect caused by deviation in detecting the deviation of the conveyance speed V is small between the sheet edges and the detection marks. On the other hand, the effect caused by deviation in detecting the deviation of the conveyance speed V is large between the sheet edges and between the detection marks in the sub-scanning direction. Similarly to the conveyance speed V, the deviation in paper skew and other factors during conveyance are also likely to be large between the sheet edges and between the detection marks.

FIG. 3B is a block diagram illustrating an example of a functional configuration of a controller 1000, a print engine 300, and an image position detector 400 of the line-head type printing device according to the embodiment. The print engine 300 corresponds to the image forming device 1. As illustrated in FIG. 3B, the controller 1000 according to the present embodiment includes an image processing unit 100 and an engine controller 200. The print engine 300 includes a print processing unit 310. The image position detector 400 includes a reading unit 401 (e.g., the image reading device 7), a sensor image acquisition unit 410, a correction value calculation unit 420, and a coordinate conversion unit 430.

The image processing unit 100 includes a raster image processor (RIP) processing unit 110 and a job information processing unit 120. The job information processing unit 120 executes a correction process to correct the position of the image formed on the recording medium such as a printing sheet M.

The execution of image forming and output is controlled based on a print job received from the outside via a network or a print job generated from image data stored in the controller 1000 according to an operator's operation. In an execution of image forming and output, the RIP processing unit 110 generates bitmap data based on the image data included in the print job and transmits the generated bitmap data to the engine controller 200.

The RIP processing unit 110 generates the bitmap data for the print engine 300 to execute image forming and output based on the image data included in the print job. The bitmap data is information about each pixel that composes the image to be formed and output.

The print engine 300 executes image forming and output based on a binary image for each of CMYK (Cyan, Magenta, Yellow, and Key plate.) By contrast, in general, the image data included in the print job is a multilevel image in which a single pixel is represented in multiple tones, such as 256 tones. Therefore, the RIP processing unit 110 converts the image data included in the print job from a multilevel image to a low-value image to generate binary bitmap data for each of CMYK.

The engine controller 200 includes a data acquisition unit 210 and an engine control unit 220. The data acquisition unit 210 acquires the print job and the bitmap data from the image processing unit 100 and operates the engine control unit 220. The engine control unit 220 causes the print engine 300 to execute image forming and output based on the print job and the bitmap data transmitted from the data acquisition unit 210. The engine control unit 220 causes the reading unit 401 to execute a reading operation based on the print job transmitted from the data acquisition unit 210.

The print processing unit 310 is an image forming unit (printing unit) that acquires the bitmap data input from the engine controller 200 and executes image forming and output on the recording medium such as the printing sheet M to output the printing sheet M having an image printed on the printing sheet M. The print processing unit 310 according to the present embodiment is implemented by any desired electrophotographic image forming mechanism, but other image forming mechanisms, such as an inkjet system, may also be used.

The reading unit 401 includes a line sensor disposed in the conveyance path of the recording medium inside the image position detector 400. The reading unit 401 scans a sheet surface of the recording medium conveyed in the vicinity of the reading unit 401 and reads a detection mark formed on the recording medium based on control information such as the print job input from the engine control unit 220.

The read image is an image generated by the reading unit 401 reading the recording medium on which the detection mark is output. Therefore, the read image is an image that indicates an output result by an image forming apparatus (e.g., the line-head type printing device.) The sensor image acquisition unit 410 acquires the read image generated by reading the recording media by the reading unit 401. The read image acquired by the sensor image acquisition unit 410 is input to the correction value calculation unit 420 and the coordinate conversion unit 430, along with the print job for which the reading unit 401 generates the read image.

The correction value calculation unit 420 calculates a correction amount to correct the position of the image (image position) formed on the recording medium at the time of image forming and output based on the center coordinates of the detection mark and the coordinates of the edge of the recording medium (sheet edge) included in the read image acquired from the sensor image acquisition unit 410. The correction value calculation unit 420 stores the calculated correction amount in a memory 420a.

Specifically, the correction value calculation unit 420 functions as an example of an image position detection unit that detects an amount of change in the print position (e.g., the detection mark in the read image) read by the reading unit 401 relative to a target print position (a target image). The correction value calculation unit 420 further functions as an example of an image position correction unit that corrects the position of the image (image position) to be formed on the recording medium in the subsequent sessions based on the detected amount of change.

Specifically, the correction value calculation unit 420 determines the image position on the second side (back side) of the recording medium based on a post-printing deviation of the print position on the first side (front side) of the recording medium, including the amount of change from the target print position, and the deviation at the time of printing of the first side from the target print position. The deviation at the time of printing of the first side (deviation at the time of printing) is a fixed deviation that the printing system (the line-head type printing device) has. When the same printing system prints the second side (the configuration that executes switchback and prints), a similar deviation at the time of printing occurs. Therefore, by correcting an image to be printed on the second side in advance while taking into account the deviation at the time of printing, it is possible to form the image at the target print position.

Alternatively, the correction value calculation unit 420 may determine the image position on the second side according to the amount of change (post-printing deviation) after correcting the image position in the direction to cancel the deviation at the time of printing. In this case, the deviation at the time of printing may be the positional deviation (e.g., misregistration) of the detection mark closest to the sheet edge (an example of the edge), which is a print origin of the first side read by the reading unit 401, with respect to the target print position. Because the amount of change of the misregistration after printing is less than the amount of change of the magnification or the distortion, misregistration may be treated as deviation at the time of printing even when the image is detected when the recording medium is sufficiently stable after printing. Therefore, even when the reading unit 401 has only one image reading unit, the correction value calculation unit 420 can correct the deviation at the time of printing.

When the reading unit 401 includes the first image reading unit that reads an image immediately after printing and the second image reading unit that reads an image after printing when a recording medium is sufficiently stable, the correction value calculation unit 420 may determine the image position on the second side based on the results of reading the images by the first image reading unit and the second image reading unit, after decomposing the deviation into two components: deviation at the time of printing and deviation after printing. Because the reading unit 401 includes the two image reading units, not only misregistration but also magnification deviation and distortion, which are susceptible to moisture change, are decomposed into two components, i.e., deviation at the time of printing and deviation after printing, and corrected.

Further, the correction value calculation unit 420 may function as an example of a reading result correction unit that corrects the detection deviation of the amount of change based on the image on which position correction has been performed. Specifically, the correction value calculation unit 420 may determine the image position on the second side based on the reading result of the print position on the first side, where correction is applied not only to the image position but also to the position of the recording medium. In other words, the correction value calculation unit 420 checks the amount of front-to-back deviation (the amount of change) from a front-to-back registration chart (an example of an image after correcting the image position) output by the print engine 300. When the amount of front-to-back deviation can be applied as a correction amount for detection deviation, the correction can be applied not only to the image position but also to the position of the recording medium. Therefore, the correction can also be applied to the position of the recording medium with no change in the misregistration on the first side.

Alternatively, the correction value calculation unit 420 may correct the detection result of the amount of change based on an input result of a correction amount from extraneous sources. Therefore, a user can visually check the amount of the front-to-back deviation from the output front-to-back registration chart and can set the correction value manually from an operation screen.

Alternatively, the correction value calculation unit 420 may correct the reading result of the position of the recording medium by an amount equal to a correction amount of the positional deviation of the detection mark with respect to adjacent sheet edges. In other words, the correction value calculation unit 420 corrects the detection deviation between adjacent sheet edges and detection marks as equivalent to the positional deviation of the recording medium.

Alternatively, the correction value calculation unit 420 may correct the reading result of the position of the recording medium by an amount obtained by multiplying the correction amount of the positional deviation of the detection mark with respect to the adjacent sheet edge by the ratio of the distance from a reading origin to the detection mark to the distance from the reading origin to the sheet edge. In other words, the correction value calculation unit 420 corrects the detection deviation between the adjacent sheet edge and the detection mark as the ratio of the distance from a reading origin to the detection mark to the distance from the reading origin to the sheet edge.

The coordinate conversion unit 430 converts the coordinates of the center of the detection mark and the coordinates of the edge of the recording medium detected by reading the detection mark formed on the first side of the recording medium into the coordinate system on the first side at the time of performing image forming and output for the second side.

A description is given below of the hardware configuration implementing the functional blocks of the controller 1000, the print engine 300, and the image position detector 400 according to the present embodiment with reference to FIG. 3C. FIG. 3C is a block diagram illustrating an example hardware configuration of the image position detector 400. In FIG. 3C, the hardware configuration of the image position detector 400 is illustrated, and the hardware configurations of the controller 1000 and the print engine 300 are the same or substantially the same as that of the image position detector 400.

As illustrated in FIG. 3C, the image position detector 400 has the same configuration as an information processing device such as a general personal computer (PC) or a server. In other words, the image position detector 400 includes a central processing unit (CPU) 10, a random access memory (RAM) 20, a read only memory (ROM) 30, a hard disk drive (HDD) 40, and an external device connection interface (I/F) 50, which are connected to each other via a bus 90.

Alternatively, the I/F 50 may be connected to a liquid crystal display (LCD) 60, an operation unit 70, and a dedicated device 80.

The CPU 10 is a computing means and controls the overall operation of the image position detector 400. The RAM 20 is a volatile storage medium from or to which information is read or written at high speed and is used as a work area for the CPU 10 to process information. The ROM 30 is a read-only, non-volatile storage medium and stores a program such as firmware. The HDD 40 is a non-volatile storage medium from or to which information can be read or written and stores, e.g., an operating system (OS), various control programs, and application programs.

The I/F 50 connects, e.g., various hardware, networks with the bus 90 and controls the various hardware or networks. The LCD 60 is, for example, a visual user interface for a user to check the operating status of the image forming apparatus via the controller 1000. The operation unit 70 is a user interface for the user to input information into the controller 1000, such as a keyboard and mouse.

The dedicated device 80 is hardware to implement dedicated functions in the controller 1000, the print engine 300, and the image position detector 400. The dedicated device in the print engine 300 is, for example, a conveyance mechanism that conveys a sheet on which an image is formed and output and a plotter that forms and outputs an image on the sheet surface.

The dedicated device in the controller 1000 and the image position detector 400 is a dedicated computing device for high-speed image processing. The dedicated computing device described above is configured as, for example, an application specific integrated circuit (ASIC.) Alternatively, the dedicated device includes a reading device such as a sensor to read the image output on the sheet.

In such a hardware configuration, a program stored in the ROM 30, the HDD 40, or a recording medium such as an optical disk is read into the RAM 20, and the CPU 10 executes operations according to the program using the hardware to implement the functions of the controller 1000, the print engine 300, and the image position detector 400 according to the present embodiment.

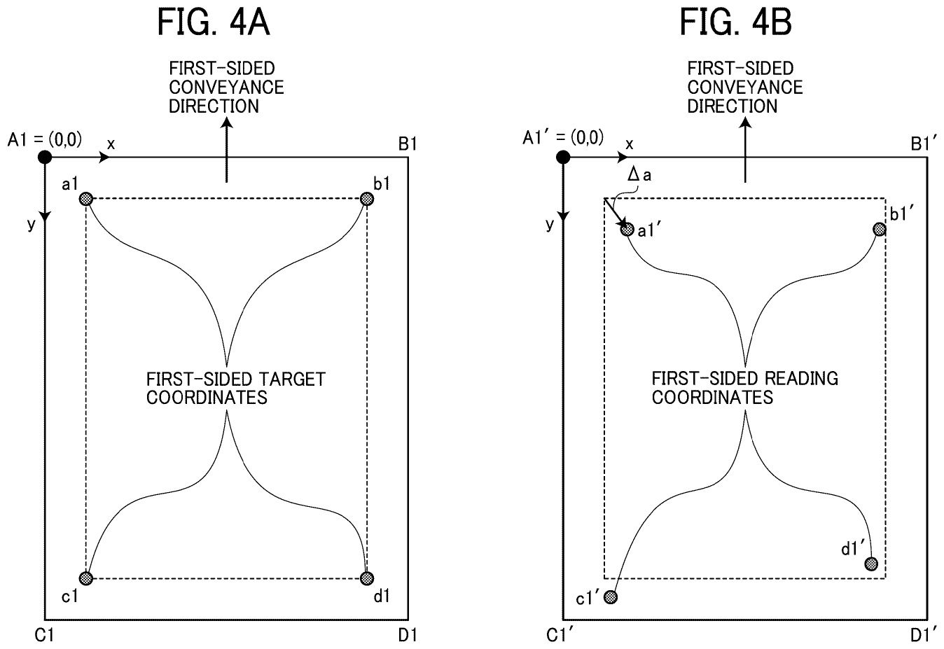

FIG. 4A and FIG. 4B are diagrams illustrating an example of target coordinates and reading coordinates of the first side of the recording medium in the line-head type printing device according to the embodiment. In the present embodiment, the target coordinates (a1, b1, c1, d1) and the reading coordinates (a1′, b1′, c1′, d1′) of the detection mark on the first side and the target coordinates (A1, B1, C1, D1) and the reading coordinates (A1′, B1′, C1′, D1′) of the sheet edges (four corners), which are the sheet edges of the recording medium (e.g. sheet), are calculated using the following equations (1) and (2). The target coordinates are the target coordinates of the detection mark and the sheet edge. The target coordinates may be, for example, the coordinates in a case where the print position that is read by the reading unit 401 is the target print position. The reading coordinates are the coordinates of the detection mark and the sheet edges that are read by the image reading device 7.

In the present embodiment, the target coordinates of the detection mark and the edge of the first side of the recording medium may be the coordinates with the top left edge (A1) of the recording medium such as a sheet as the origin (0, 0), as represented in Equation (1) below. The upper case letter of the alphabet represents the coordinate of the sheet edge of the recording medium, and the lower case letter of the alphabet represents the coordinate of the detection mark. The numeral “1” represents a coordinate system with the upper left sheet edge (A1) of the first side (e.g., front side) of the recording medium in the conveyance direction as the reference origin (origin (0,0).) The numeral “2” represents a coordinate system with the upper left sheet edge (A2) of the second side (e.g., back side) of the recording medium in the conveyance direction as the reference origin (origin (0,0)).

$$\begin{matrix}Equation 1 & \\ \begin{matrix}< sheet edge > & < detention mark > \\ ( \begin{matrix}A 1 x \\ A 1 y\end{matrix} ) = ( \begin{matrix}0 \\ 0\end{matrix} ) & ( \begin{matrix}a 1 x \\ a 1 y\end{matrix} ) = ( \begin{matrix}ax \\ ay\end{matrix} ) \\ ( \begin{matrix}B 1 x \\ B 1 y\end{matrix} ) = ( \begin{matrix}Bx \\ By\end{matrix} ) & ( \begin{matrix}b 1 x \\ b 1 y\end{matrix} ) = ( \begin{matrix}bx \\ by\end{matrix} ) \\ ( \begin{matrix}C 1 x \\ C 1 y\end{matrix} ) = ( \begin{matrix}Cx \\ Cy\end{matrix} ) & ( \begin{matrix}c 1 x \\ c 1 y\end{matrix} ) = ( \begin{matrix}cx \\ cy\end{matrix} ) \\ ( \begin{matrix}D 1 x \\ D 1 y\end{matrix} ) = ( \begin{matrix}Dx \\ Dy\end{matrix} ) & ( \begin{matrix}d 1 x \\ d 1 y\end{matrix} ) = ( \begin{matrix}dx \\ dy\end{matrix} )\end{matrix} & ( 1 )\end{matrix}$$

In the present embodiment, the reading coordinates of the detection mark and the sheet edge on the first side may be the coordinates with the upper left edge (A1′) of the recording media such as a sheet as the origin (0, 0), as represented in Equation (2) below. The positional deviation (e.g., misregistration) Δa indicates the misregistration of the reading coordinates relative to the target coordinates based on the conveyance direction at the time of printing the image on the first side. The misregistration Δa is the amount of deviation of the reading coordinates of the read detection mark a1′ relative to the target coordinates of the detection mark a1 near the origin (0, 0), as represented in Equation (3) below.

$$\begin{matrix}Equation 2 & \\ \begin{matrix}< sheet edge > & < detention mark > \\ ( \begin{matrix}A {1}^{′} x \\ A {1}^{′} y\end{matrix} ) = ( \begin{matrix}0 \\ 0\end{matrix} ) & ( \begin{matrix}a {1}^{′} x \\ a {1}^{′} y\end{matrix} ) = ( \begin{matrix}ax + Δ ax \\ ay + Δ ay\end{matrix} ) \\ ( \begin{matrix}B {1}^{′} x \\ B {1}^{′} y\end{matrix} ) = ( \begin{matrix}Bx + Δ Bx \\ By + Δ By\end{matrix} ) & ( \begin{matrix}b {1}^{′} x \\ b {1}^{′} y\end{matrix} ) = ( \begin{matrix}bx + Δ bx \\ by + Δ by\end{matrix} ) \\ ( \begin{matrix}C {1}^{′} x \\ C {1}^{′} y\end{matrix} ) = ( \begin{matrix}Cx + Δ Cx \\ Cy + Δ Cy\end{matrix} ) & ( \begin{matrix}c {1}^{′} x \\ c {1}^{′} y\end{matrix} ) = ( \begin{matrix}cx + Δ cx \\ cy + Δ cy\end{matrix} ) \\ ( \begin{matrix}D {1}^{′} x \\ D {1}^{′} y\end{matrix} ) = ( \begin{matrix}Dx + Δ Dx \\ Dy + Δ Dx\end{matrix} ) & ( \begin{matrix}d {1}^{′} x \\ d {1}^{′} y\end{matrix} ) = ( \begin{matrix}dx + Δ dx \\ dy + Δ dy\end{matrix} )\end{matrix} & ( 2 )\end{matrix}$$

$$\begin{matrix}Equation 3 & \\ Δ a = ( \begin{matrix}a {1}^{′} x - a 1 x \\ a {1}^{′} y - a 1 y\end{matrix} ) = ( \begin{matrix}Δ ax \\ Δ ay\end{matrix} ) & ( 3 )\end{matrix}$$

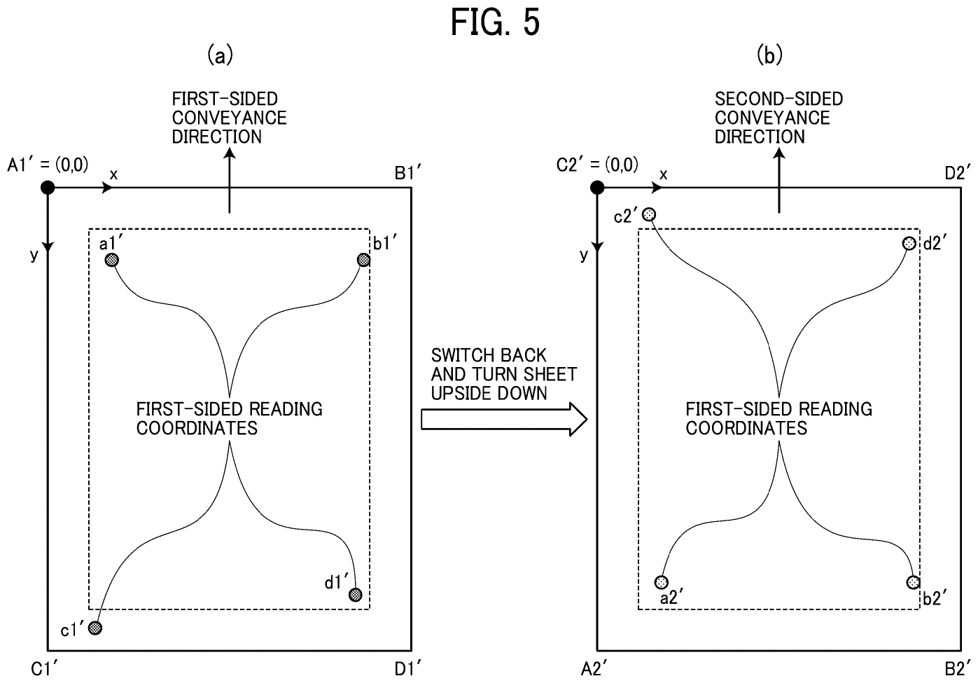

FIG. 5 is a diagram illustrating an example of the target coordinates and the reading coordinates for the first side and second side of the recording medium in the line-head type printing device. Equations (4) and (5) below represent the target coordinates and the reading coordinates of each of the detection mark and the edges on the first side of the recording medium when the detection mark and the edges are inverted vertically and converted with respect to the conveyance direction at the time of printing the image on the second side. Specifically, Equation (4) represents the target coordinates of the first side when the upper left edge C2 of the sheet edge of the recording medium such as a sheet is the origin (0, 0). Equation (5) represents the reading coordinates of the first side when the upper left edge C2′ of the sheet edge of the recording medium such as a sheet is the origin (0, 0).

$$\begin{matrix}Equation 4 & \\ \begin{matrix}< sheet edge > & < detention mark > \\ ( \begin{matrix}C 1 x \\ C 1 y\end{matrix} ) = ( \begin{matrix}0 \\ 0\end{matrix} ) & ( \begin{matrix}c 2 x \\ c 2 y\end{matrix} ) = ( \begin{matrix}cx - Cx \\ Cy - cy\end{matrix} ) \\ ( \begin{matrix}D 2 x \\ D 2 y\end{matrix} ) = ( \begin{matrix}Dx - Cx \\ Cy - Dy\end{matrix} ) & ( \begin{matrix}d 2 x \\ d 2 y\end{matrix} ) = ( \begin{matrix}dx - Cx \\ Cy - dy\end{matrix} ) \\ ( \begin{matrix}A 2 x \\ A 2 y\end{matrix} ) = ( \begin{matrix}Ax - Cx \\ Cy - Ay\end{matrix} ) & ( \begin{matrix}a 2 x \\ a 2 y\end{matrix} ) = ( \begin{matrix}ax - Cx \\ Cy - ay\end{matrix} ) \\ ( \begin{matrix}B 2 x \\ B 2 y\end{matrix} ) = ( \begin{matrix}Bx - Cx \\ Cy - By\end{matrix} ) & ( \begin{matrix}b 2 x \\ b 2 y\end{matrix} ) = ( \begin{matrix}bx - Cx \\ Cy - by\end{matrix} )\end{matrix} & ( 4 )\end{matrix}$$

$$\begin{matrix}Equation 5 & \\ \begin{matrix}< sheet edge > & < detention mark > \\ ( \begin{matrix}C {1}^{′} x \\ C {1}^{′} y\end{matrix} ) = ( \begin{matrix}0 \\ 0\end{matrix} ) & ( \begin{matrix}c {2}^{′} x \\ c {2}^{′} y\end{matrix} ) = ( \begin{matrix}cx + Δ cx - Cx \\ Cy - cy - Δ cy\end{matrix} ) \\ ( \begin{matrix}D {2}^{′} x \\ D {2}^{′} y\end{matrix} ) = ( \begin{matrix}Dx + Δ Dx - Cx \\ Cy - Dy - Δ Dy\end{matrix} ) & ( \begin{matrix}d {2}^{′} x \\ d {2}^{′} y\end{matrix} ) = ( \begin{matrix}dx + Δ dx - Cx \\ Cy - dy - Δ dy\end{matrix} ) \\ ( \begin{matrix}A {2}^{′} x \\ A {2}^{′} y\end{matrix} ) = ( \begin{matrix}Ax + Δ Ax - Cx \\ Cy - Ay - Δ Ay\end{matrix} ) & ( \begin{matrix}a {2}^{′} x \\ a {2}^{′} y\end{matrix} ) = ( \begin{matrix}ax + Δ ax - Cx \\ Cy - ay - Δ ay\end{matrix} ) \\ ( \begin{matrix}B {2}^{′} x \\ B {2}^{′} y\end{matrix} ) = ( \begin{matrix}Bx + Δ Bx - Cx \\ Cy - By - Δ By\end{matrix} ) & ( \begin{matrix}b {2}^{′} x \\ b {2}^{′} y\end{matrix} ) = ( \begin{matrix}bx + Δ bx - Cx \\ Cy - by - Δ by\end{matrix} )\end{matrix} & ( 5 )\end{matrix}$$

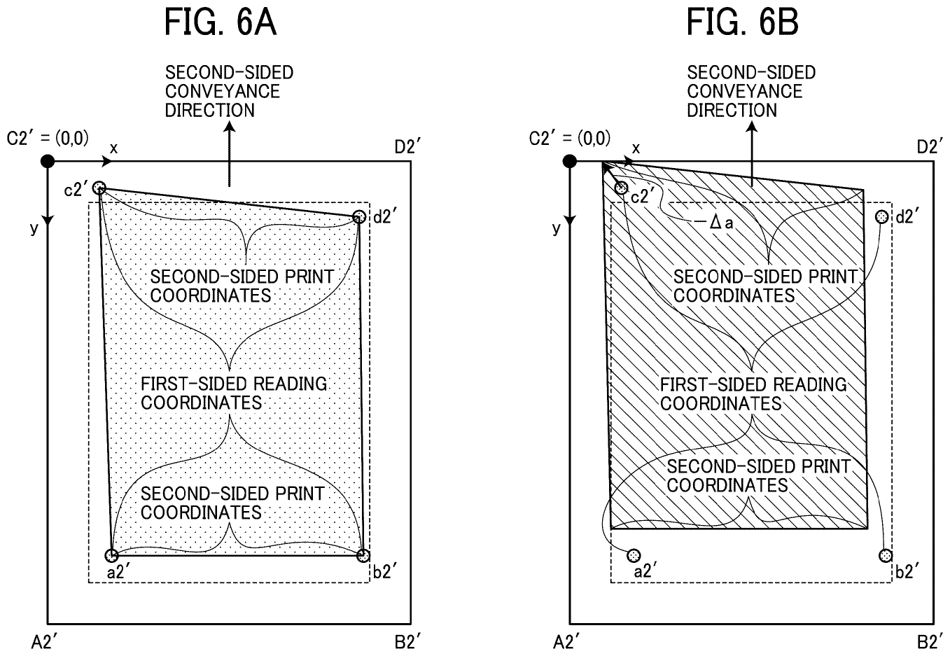

FIG. 6A is a diagram illustrating an example of the printing coordinates of the second side in the comparative example. In the comparative example, as illustrated in FIG. 6A, the print image is formed on the second side at a position that matches the reading coordinates when the detection mark on the first side and the reading coordinates of the edge of the recording medium are inverted vertically and converted with respect to the conveyance direction at the time of printing on the second side. However, in that case, the misregistration occurs at the time of printing on the second side in the same manner as at the time of printing on the first side, resulting in the misregistration of +Δa for the printing coordinates on the second side with respect to the print coordinates on the first side.

FIG. 6B is a diagram illustrating an example of the printing coordinates of the second side according to the present embodiment. In the present embodiment, the correction value calculation unit 420 corrects the image position of the second side and forms the printed image on the second side by shifting the image position by −Δa in advance by the print processing unit 310, as illustrated in FIG. 6B. Therefore, after the misregistration at the time of printing occurs, the misregistration between the print coordinates of the first side and the print coordinates of the second side becomes zero, and the front-to-back registration accuracy is enhanced. The printing coordinates may be the coordinates of the position where the image is formed on the recording medium.

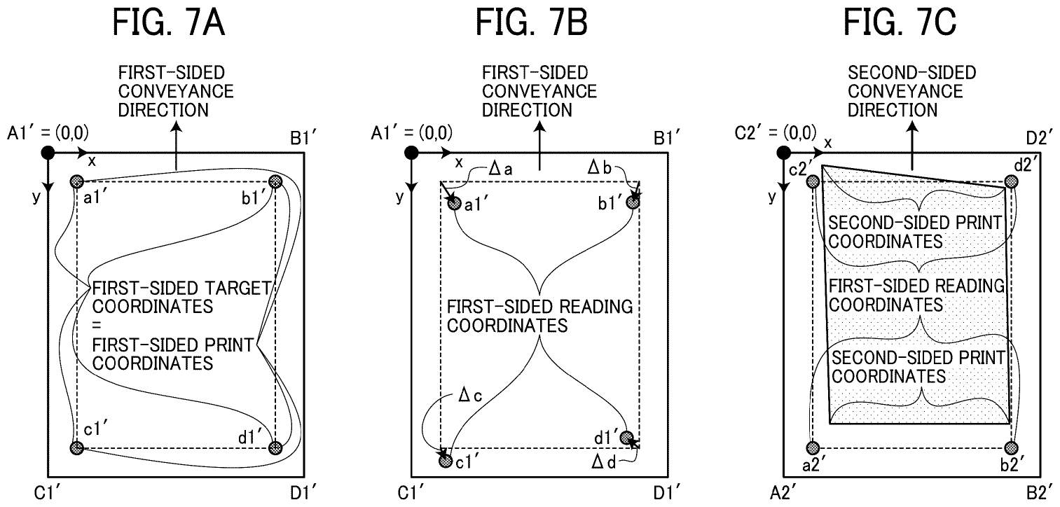

FIG. 7A to FIG. 7C are diagrams illustrating an example of a front-to-back position misregistration due to the deviation in detecting the image position. Next, an example of the front-to-back position misregistration due to the deviation of detecting by a reading system (the image reading device 7) assuming that the reading system is capable of printing correctly with respect to the target coordinates, is described. For the sake of simplicity, it is assumed that there is no deviation due to, e.g., drying after printing. The front-to-back position misregistration may be the positional deviation between the printed image on the first side and the printed image on the second side.

FIG. 7A is a diagram illustrating the case where the target coordinates of the first side match the printing coordinates of the first side. FIG. 7B is a diagram illustrating the reading coordinates of the first side when the first side is detected out of alignment with the printing coordinates of the first side illustrated in FIG. 7A. FIG. 7B illustrates the case where the detection marks at the four corners of the recording medium are deviated by Δa, Δb, Δc, and Δd at respective positions. FIG. 7C is a diagram illustrating an example of the printing coordinates of the second side of the detection mark when the second side is printed in the state illustrated in FIG. 7B. As illustrated in FIG. 7C, the reading coordinates illustrated in FIG. 7B are inverted vertically, the printing coordinates on the second side are determined so that the printing coordinates match with respect to the conveyance direction of the second side, and the printing is executed at the targeted position, resulting in a front-to-back position misregistration by the amount of the deviation of detecting.

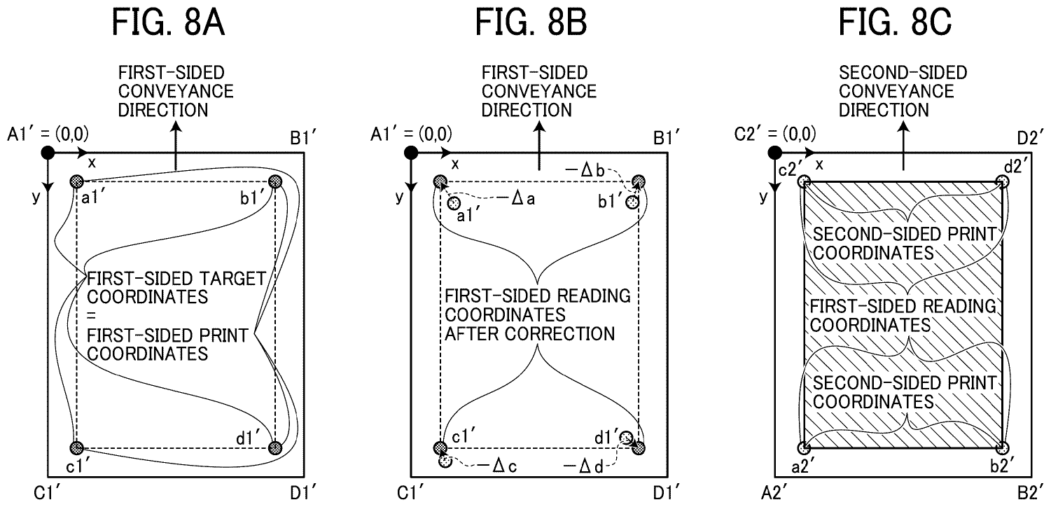

FIG. 8A to FIG. 8C are diagrams illustrating an example of correcting front-to-back position misregistration due to the deviation in detecting the image position. One method to solve the problem described referring to FIG. 7C is to correct the deviation of detecting that the reading system (the image reading device 7) includes. In the correction method (correcting the deviation of detecting the image position) the correction value calculation unit 420 causes the print processing unit 310 to print an image that indicates the amount of front-to-back position misregistration (the amount of the front-to-back position misregistration) at the four corners of the recording medium in advance, calculates the amount of the front-to-back position misregistration. The correction amount for the front-to-back position misregistration is then set on, e.g., the user operation screen, and the corrected reading coordinates are calculated by adding the correction amount to the subsequent reading coordinates. Using the correction method, the printing coordinates on the first side and the corrected reading coordinates on the first side match, and as illustrated in FIG. 8, the printing coordinates on the second side are in a position (coordinates) with no front-to-back position misregistration with respect to the printing coordinates on the first side.

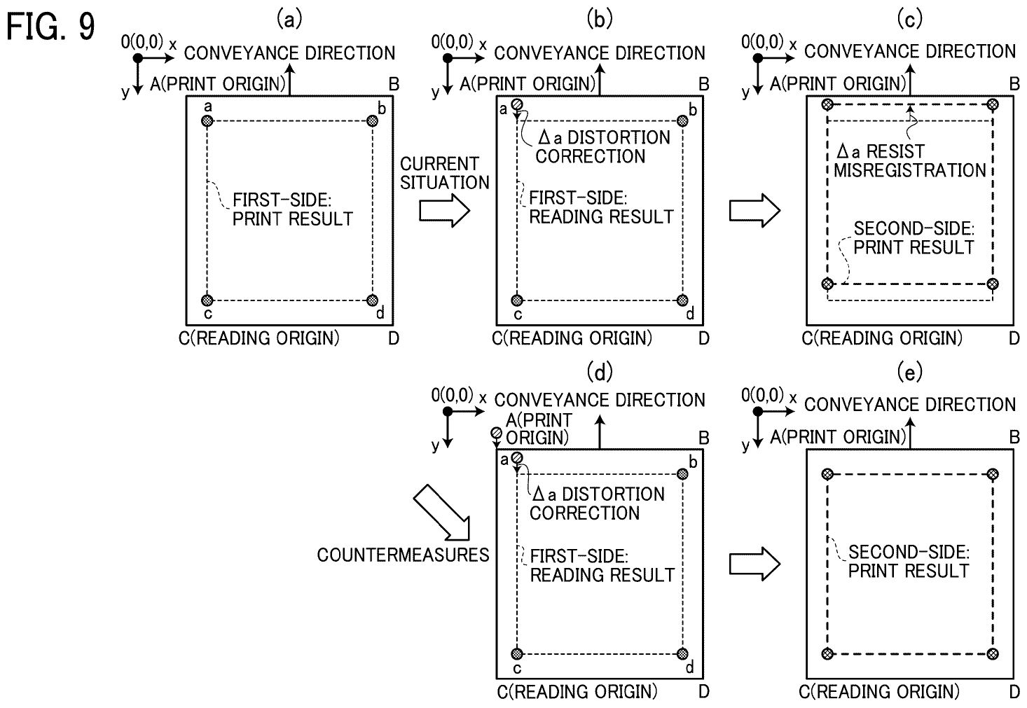

FIG. 9 is a diagram illustrating side effects caused by correcting the deviation in detecting the image position and an example of countermeasures against the side effects. First, the side effects caused by correcting the deviation in detecting the image position are described. For the sake of simplicity, it is assumed that there is no deviation due to, e.g., drying after printing. Part (a) of FIG. 9 illustrates the case where the target coordinates of the first side match the printing coordinates of the first side. Part (b) of FIG. 9 illustrates an example case where only the detection mark a is deviated by Aa. In such case, as described referring to FIG. 8A to FIG. 8C, when the correcting the deviation of detecting of the image position (distortion correction) is applied in advance only to the detection mark a by positional deviation Aa, the detection result of the detection marks is corrected to the correct detection result in subsequent detections.

When the image reading device 7 is on the double-sided conveyance path as illustrated in FIG. 1, the print origin A (origin at the time of printing) and the reading origin C (origin at the time of reading) are different because the conveyance direction is reversed by the switchback at the reversing device 5 when the first side is printed and when the first side is read. Therefore, it is necessary to consider the coordinates of the sheet edge of the recording medium at that time. When the detection result (reading coordinates) of the detection mark a is deviated by Aa, the detection result (reading coordinates) may be deviated by about Aa for the print origin A as well. This is because, as described with the configuration of the image reading device 7 illustrated in FIG. 3A, the relationship between the sheet edges at each of the four corners and the detection marks of the recording medium has a small effect caused by the deviation in detecting, but an effect caused by the deviation in detecting between the sheet edges and the detection marks in the sub-scanning direction is large. When the print origin A is also deviated by Aa as well as the detection mark a, the misregistration at the time of printing described referring to FIG. 4A and FIG. 4B is 0.

However, as illustrated in part (b) of FIG. 9, by correcting the deviation in detecting the image position only to the detection mark a, the misregistration of the print origin A and the detection mark a at the time of printing becomes Aa. As a result, when the correction described referring to FIG. 6A and FIG. 6B is applied, the print position (print image) on the second side results in a misregistration of Aa with respect to the print result (print image) on the first side (see part (c) of FIG. 9.)

As illustrated in part (d) of FIG. 9, the correction value calculation unit 420 applies the correction of the deviation in detecting the image position, which has been applied to the detection mark, also to the coordinates of the sheet edge of the recording medium. Since the correction can change only the relationship between the reading origin C and the detection mark a without changing the relationship between the print origin A and the detection mark a, the front-to-back registration accuracy can be enhanced even when the correction described referring to FIG. 6A and FIG. 6B is applied (see part (e) of FIG. 9). The correction to the coordinates of the sheet edge of the recording medium may be performed by applying exactly the same value as the correction value for the detection mark a. A value obtained by multiplying the ratio of the distance between the print origin A and the reading origin C to the distance between the detection mark a and the reading origin C by Aa may be applied to the print origin A.

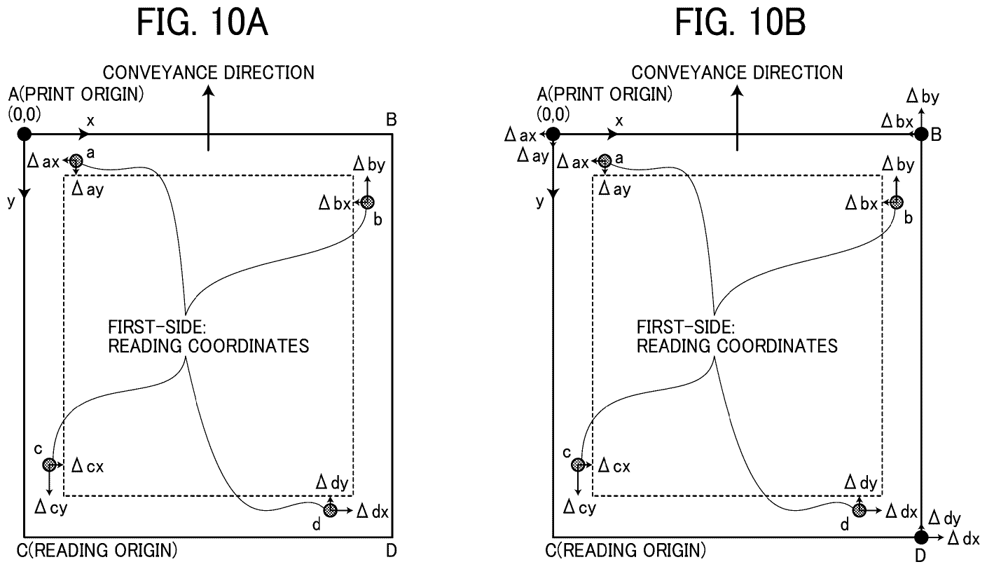

FIG. 10A and FIG. 10B are diagrams illustrating an example of coordinate formulas to compensate the side effects caused by correcting the deviation in detecting the image position. When correction of the deviation in detecting the image position is applied only to the detection marks, the coordinate equations for the sheet edges and the detection marks are expressed by the following equation (6) (see FIG. 10A). In contrast, when the correction of the deviation in detecting the image position is applied to the detection marks and the sheet edges as countermeasures against the side effects, the coordinate equations for the sheet edges and the detection marks are expressed by the following equation (7) (see FIG. 10B). As the correction amount for the deviation in detecting is calculated based on the reading origin C, no correction value is applied to the reading origin C. When there is a reading path on the single-sided conveyance path, the reading origin is point A. Therefore, the equations would not be applicable.

$$\begin{matrix}Equation 6 & \\ \begin{matrix}< sheet edge > & < detention mark > \\ ( \begin{matrix}A 1 x \\ A 1 y\end{matrix} ) = ( \begin{matrix}0 \\ 0\end{matrix} ) & ( \begin{matrix}a 1 x \\ a 1 y\end{matrix} ) = ( \begin{matrix}ax + Δ ax \\ ay + Δ ay\end{matrix} ) \\ ( \begin{matrix}B 1 x \\ B 1 y\end{matrix} ) = ( \begin{matrix}Bx \\ By\end{matrix} ) & ( \begin{matrix}b 1 x \\ b 1 y\end{matrix} ) = ( \begin{matrix}bx + Δ bx \\ by + Δ by\end{matrix} ) \\ ( \begin{matrix}C 1 x \\ C 1 y\end{matrix} ) = ( \begin{matrix}Cx \\ Cy\end{matrix} ) & ( \begin{matrix}c 1 x \\ c 1 y\end{matrix} ) = ( \begin{matrix}cx + Δ cx \\ cy + Δ cy\end{matrix} ) \\ ( \begin{matrix}D 1 x \\ D 1 y\end{matrix} ) = ( \begin{matrix}Dx \\ Dy\end{matrix} ) & ( \begin{matrix}d 1 x \\ d 1 y\end{matrix} ) = ( \begin{matrix}dx + Δ dx \\ dy + Δ dy\end{matrix} )\end{matrix} & ( 6 )\end{matrix}$$

$$\begin{matrix}Equation 7 & \\ \begin{matrix}< sheet edge > & < detention mark > \\ ( \begin{matrix}A 1 x \\ A 1 y\end{matrix} ) = ( \begin{matrix}Δ ax \\ Δ ay\end{matrix} ) & ( \begin{matrix}a 1 x \\ a 1 y\end{matrix} ) = ( \begin{matrix}ax + Δ ax \\ ay + Δ ay\end{matrix} ) \\ ( \begin{matrix}B 1 x \\ B 1 y\end{matrix} ) = ( \begin{matrix}Bx + Δ bx \\ By + Δ by\end{matrix} ) & ( \begin{matrix}b 1 x \\ b 1 y\end{matrix} ) = ( \begin{matrix}bx + Δ bx \\ by + Δ by\end{matrix} ) \\ ( \begin{matrix}C 1 x \\ C 1 y\end{matrix} ) = ( \begin{matrix}Cx \\ Cy\end{matrix} ) & ( \begin{matrix}c 1 x \\ c 1 y\end{matrix} ) = ( \begin{matrix}cx + Δ cx \\ cy + Δ cy\end{matrix} ) \\ ( \begin{matrix}D 1 x \\ D 1 y\end{matrix} ) = ( \begin{matrix}Dx + Δ dx \\ Dy + Δ dy\end{matrix} ) & ( \begin{matrix}d 1 x \\ d 1 y\end{matrix} ) = ( \begin{matrix}dx + Δ dx \\ dy + Δ dy\end{matrix} )\end{matrix} & ( 7 )\end{matrix}$$

As described above, the line-head type printing device according to the present embodiment can correct the image position of the second side in the direction that compensates the misregistration at the time of printing, in addition to correcting the image position of the second side to match the image position of the first side, thus further reducing the front-to-back misregistration.

The program to be executed by the line-head type printing device is provided pre-embedded in, e.g., the ROM 30. The program executed by the line-head type printing device according to the present embodiment may be stored in any computer-readable recording medium, such as a compact disc read-only memory (CD-ROM), a flexible disk (FD), a compact disc-recordable (CD-R), or a digital versatile disc (DVD), in an installable or executable file format and provided as a computer program product.

The program to be executed by the line-head type printing device according to the present embodiment may be stored on a computer connected to a network such as the Internet and downloaded via the network. The program to be executed by the line-head type printing device may be provided or distributed via a network such as the Internet.

The program to be executed by the line-head type printing device according to the present embodiment is in a modular configuration including various units (e.g., the sensor image acquisition unit 410, the correction value calculation unit 420, the coordinate conversion unit 430.) As hardware, as the CPU 10, which is an example of the processor, reads the program from the ROM 30 and executes the program, the above-described functional units are loaded and implemented in a main memory.

Note that in the embodiment described above, the image forming apparatus is applied to a multi-function peripheral printer (MFP) having at least two of copying, printing, scanning, and facsimile functions. Alternatively, the image forming apparatus may be applied to any image forming apparatus such as for example, a copier, a printer, a scanner, or a facsimile machine.

Aspects of the present disclosure are as follows.

According to Aspect 1, an image forming apparatus includes a conveyance device, a printing device, an image reading device, and circuitry.

The conveyance device conveys a recording medium having a first side and a second side.

The printing device forms an image on the conveyed recording medium.

The image reading device reads a print position based on the formed image. The print position is a position of the formed image.

The circuitry detects an amount of change in the print position that is read relative to a target print position.

The circuitry corrects an image position based on the detected amount of change. The image position is a position of an image to be formed on the recording medium in subsequent image formations.

The circuitry determines the image position on the second side of the recording medium based on deviations of the print position on the first side of the recording medium from the target print position. The deviations include a deviation at a time of printing the first side, and a post-printing deviation after printing and are the detected amount of change.

According to Aspect 2, in the image forming apparatus of Aspect 1, the circuitry determines the image position on the second side according to the post-printing deviation after correcting the image position in a direction to compensate the deviation at the time of printing.

According to Aspect 3, in the image forming apparatus of Aspect 1 or 2, the deviation at the time of printing includes a positional deviation of a detection mark closest to an edge of a print origin on the first side, read by the image reading device.

According to Aspect 4, in the image forming apparatus of any one of Aspects 1 to 3, the image reading device includes a first image reading device to read the image immediately after printing and a second image reading device to read the image after printing when the recording medium is sufficiently stable.

In determining the image position on the second side, the circuitry decomposes the deviations into two components including the deviation at the time of printing and the post-printing deviation, based on results of reading the image by the first image reading device and the second image reading device.

According to Aspect 5, in the image forming apparatus of Aspect 3, the circuitry corrects a detection deviation in detecting the amount of change based on the image having the image position corrected. The circuitry determines the image position on the second side based on a reading result of the print position on the first side for which corrections are applied both to the image position and a position of the recording medium.

According to Aspect 6, in the image forming apparatus of Aspect 5, the circuitry corrects a detection result of the amount of change based on an input result of a correction amount input from an extraneous source.

According to Aspect 7, in the image forming apparatus according of Aspect 5, the circuitry corrects the reading result of the position of the recording medium by an amount equal to a correction amount of the positional deviation of the detection mark with respect to an adjacent sheet edge.

According to Aspect 8, in the image forming apparatus of Aspect 5, the circuitry corrects the reading result of the position of the recording medium by an amount obtained by multiplying a correction amount of the positional deviation of the detection mark with respect to an adjacent sheet edge by a ratio of a distance from a reading origin to the detection mark to a distance from the reading origin to a sheet edge.

According to Aspect 9, an image forming method executed by an image forming apparatus including an image reading device, includes detecting, from an image printed on a recording medium having a first side and a second side, an amount of change in a print position read by the image reading device relative to a target print position.

The image forming method includes determining an image position on the second side of the recording medium based on deviations of the print position on the first side of the recording medium from the target print position. The deviations include a deviation at a time of printing the first side, and a post-printing deviation after printing and are the detected amount of change.

The image forming method includes correcting the image position based on the detected amount of change. The image position is a position of an image to be formed on the recording medium in subsequent image formations.

According to Aspect 10, a non-transitory recording medium storing a plurality of instructions which, when executed by one or more processors, causes the one or more processors to perform a method. The method includes detecting, from an image printed on a recording medium having a first side and a second side, an amount of change in a print position read by an image reading device relative to a target print position.

The method includes determining an image position on the second side of the recording medium based on deviations of the print position on the first side of the recording medium from the target print position. The deviations include a deviation at a time of printing the first side, and a post-printing deviation after printing and are the detected amount of change.

The method includes correcting the image position based on the detected amount of change. The image position is a position of an image to be formed on the recording medium in subsequent image formations.

In the technique according to the related art, the image position on the second side is corrected to match the image position on the first side. However, in that case, it is not possible to correct deviation at the time of printing.

According to the one or more embodiments of the present disclosure, front-to-back misregistration is further reduced.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a conveyance device to convey a recording medium having a first side and a second side;
a printing device to form an image on the conveyed recording medium;
an image reading device to read a print position based on the formed image, the print position being a position of the formed image; and
circuitry configured to:
detect an amount of change in the print position that is read relative to a target print position; and
correct an image position based on the detected amount of change, the image position being a position of an image to be formed on the recording medium in subsequent image formations,
wherein the circuitry determines the image position on the second side of the recording medium based on deviations of the print position on the first side of the recording medium from the target print position,
the deviations including a deviation at a time of printing the first side, and a post-printing deviation after printing and being the detected amount of change.

2. The image forming apparatus according to claim 1, wherein the circuitry determines the image position on the second side according to the post-printing deviation after correcting the image position in a direction to compensate the deviation at the time of printing.

3. The image forming apparatus according to claim 1, wherein the deviation at the time of printing includes a positional deviation of a detection mark closest to an edge of a print origin on the first side, read by the image reading device.

4. The image forming apparatus according to claim 1, wherein the image reading device includes a first image reading device to read the image immediately after printing and a second image reading device to read the image after printing when the recording medium is sufficiently stable, and
wherein, in determining the image position on the second side, the circuitry decomposes the deviations into two components including the deviation at the time of printing and the post-printing deviation, based on results of reading the image by the first image reading device and the second image reading device.

5. The image forming apparatus according to claim 3, wherein the circuitry is further configured to:
correct a detection deviation in detecting the amount of change based on the image having the image position corrected; and
determine the image position on the second side based on a reading result of the print position on the first side for which corrections are applied both to the image position and a position of the recording medium.

6. The image forming apparatus according to claim 5, wherein the circuitry corrects a detection result of the amount of change based on an input result of a correction amount input from an extraneous source.

7. The image forming apparatus according to claim 5, wherein the circuitry corrects the reading result of the position of the recording medium by an amount equal to a correction amount of the positional deviation of the detection mark with respect to an adjacent sheet edge.

8. The image forming apparatus according to claim 5, wherein the circuitry corrects the reading result of the position of the recording medium by an amount obtained by multiplying a correction amount of the positional deviation of the detection mark with respect to an adjacent sheet edge by a ratio of a distance from a reading origin to the detection mark to a distance from the reading origin to a sheet edge.

9. An image forming method executed by an image forming apparatus including an image reading device, comprising:
detecting, from an image printed on a recording medium having a first side and a second side, an amount of change in a print position read by the image reading device relative to a target print position; and
determining an image position on the second side of the recording medium based on deviations of the print position on the first side of the recording medium from the target print position,
the deviations including a deviation at a time of printing the first side, and a post-printing deviation after printing and being the detected amount of change; and
correcting the image position based on the detected amount of change, the image position being a position of an image to be formed on the recording medium in subsequent image formations.

10. A non-transitory recording medium storing a plurality of instructions which, when executed by one or more processors, causes the one or more processors to perform a method, the method comprising:
detecting, from an image printed on a recording medium having a first side and a second side, an amount of change in a print position read by an image reading device relative to a target print position; and
determining an image position on the second side of the recording medium based on deviations of the print position on the first side of the recording medium from the target print position,
the deviations including a deviation at a time of printing the first side, and a post-printing deviation after printing and being the detected amount of change; and
correcting the image position based on the detected amount of change, the image position being a position of an image to be formed on the recording medium in subsequent image formations.
